(19) United States
(12) Patent Application Publication
(10) Pub. No.: US 2005/0129558 A1
(43) Pub. Date: Jun. 16, 2005

(54) Electric compressor and assembling method thereof

(75) Inventors: Masahiko Makino, Shiga (JP); Nobuaki Ogawa, Shiga (JP); Yukihiro Fujiwara, Shiga (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: MATSUSHITA ELECTRIC INDUSTRIAL CO., LTD., Kadoma-shi (JP)

(21) Appl. No.: 11/011,050

(22) Filed: Dec. 15, 2004

(30) Foreign Application Priority Data
Dec. 15, 2003 (JO) 2003-416196

(51) Int. Cl. F04C 18/00; F01C 1/02; F03C 4/00; F01C 1/063; F03C 2/00; F04C 2/00

(52) U.S. Cl. 418/55.6

(57) ABSTRACT

The present invention provides an electric compressor in which the centering operation between a container and a main bearing member can be carried out precisely, and the compressor can easily be assembled. A main bearing member is provided at its peripheral edge with an inserting portion and an abutting portion, an outer diameter of the inserting portion is set smaller than that of the abutting portion. The outer diameter of the inserting portion is set slightly smaller than an inner diameter of an opening end of the container. With this structure, a centering operation can be carried out precisely and easily, and the reliability and performance of the compressor are enhanced, and costs thereof can be reduced.

### TECHNICAL FIELD

The present invention relates to a compression mechanism, an electric motor which drives the compression mechanism through a drive shaft, an electric compressor such as a scroll compressor having a container in which the electric motor is accommodated, and an assembling method of the electric compressor.

### BACKGROUND TECHNIQUE

Generally, a pressure-proof container is used in this kind of compressor, and a scroll compressor or a rotary compressor is employed as the compression mechanism, and a stator and a rotor made of iron-based material around which copper wires are wound are used as the electric motor.

As an electric compressor used in a living space, a hermetical electric compressor comprising an iron housing is widely known. As an electric compressor used for air conditioning in a vehicle, a semi-hermetical electric compressor comprising a light aluminum housing has become mainstream because such an electric compressor can easily be mounted on a vehicle.

According to a conventional structure of the latter electric compressor as shown in patent document 1 [Japanese Patent Application Laid-open No.H9-287585], a housing, a compression mechanism and a bearing member are made of light metal such as aluminum, and these parts are axially fixed in an axial direction using bolts, thereby constituting a pressure-proof container.

In a compressor used in a vehicle, in order to make it possible to operate the compressor without vibration or excessive load over the long run, the compression mechanism, the electric motor and the drive shaft are aligned with each other such that their axes are matched with each other and no deflection or no twisting is generated so that the entire compressor can smoothly be operated.

According to the conventional structure (scroll compressor) shown in patent document 1, four projections are integrally formed in the radial direction on each of outer peripheries of a main bearing member and a housing in which the electric motor is accommodated, and two centering holes are provided in the projections. Pins are fitted into the centering holes to align the members so that the main shaft can smoothly rotate.

According to such a centering method, however, a strict dimensional tolerance is required between the pin hole position and the axial center, high precision working is required for the inserting pins and the pin holes, and this becomes a factor which increases costs of the compressor.

It is an object of the present invention to provide a compressor in which the centering adjustment is easy and the compressor can be assembled precisely.

### DISCLOSURE OF THE INVENTION

According to a first aspect of the present invention, there is provided an electric compressor comprising a compression mechanism which sucks, compresses and discharges a refrigerant, a drive shaft which drives the compression mechanism, a main bearing member which holds the drive shaft, an electric motor which drives the drive shaft, and a container which accommodates the electric motor, in which the compression mechanism, the main bearing member and the container are axially butted and connected to each other, wherein the main bearing member is provided at its peripheral edge with an inserting portion and an abutting portion, an outer diameter of the inserting portion is set smaller than an outer diameter of the abutting portion, and the outer diameter of the inserting portion is set slightly smaller than an inner diameter of an opening end of the container.

With this aspect, the center of the main shaft and the center of the container can match with each other by fitting the main bearing member to the container.

According to a second aspect of the invention, in the electric compressor of the first aspect, the compression mechanism comprises a stationary scroll, a movable scroll and the drive shaft which turns the movable scroll, and in a state in which a rotor of the electric motor is previously fixed to the drive shaft, the stationary scroll, the main bearing member and the container are axially butted against and connected to each other.

With this structure, the centering operation of the scroll compression mechanism including the rotor of the electric motor can previously be carried out and then, the centering operation between the rotor and the stator of the electric motor can be carried out.

According to a third aspect of the invention, in the electric compressor of the first aspect, seal means which seals between the atmosphere and a high pressure chamber in the container is provided on any one of a abutment surface between the main bearing member abutting portion and the container, a fitting surface between the inserting portion and the container, an abutment surface of the container which abuts against the abutting portion, and an inner peripheral surface of the container which is fitted to the inserting portion.

With this structure, the high pressure portion and the atmosphere can reliably be isolated from each other, and the reliability of the compressor is enhanced.

According to a fourth aspect of the invention, in the electric compressor of the third aspect, the seal means comprises an annular groove provided in the abutment surface of the abutting portion, and an annular seal provided on the groove.

With this structure, an inexpensive O-ring can be used as the seal means.

According to a fifth aspect of the invention, in the electric compressor of the third aspect, the seal means comprises a groove formed in an entire outer peripheral surface of the inserting portion, and an annular seal provided on the groove.

According to a sixth aspect of the invention, in the electric compressor of the fourth or fifth aspect, the annular seal is made of rubber.

According to a seventh aspect of the invention, in the electric compressor of the first aspect, the inserting portion of the main bearing member is formed into a truncated shape whose outer diamet4er is gradually reduced toward its tip end, a thickness of the opening end of the container to which the inserting portion is inserted becomes gradually reduced toward the opening end such that an inner peripheral surface thereof matches with an outer diameter of the inserting portion.

According to this structure, since both the main bearing member and the container are formed into the truncated shapes, they butt against each other easily such that their centers automatically align with each other along the tapered surface of the truncated shape. As a result, the main bearing member and smoothly be fitted into the housing, and the operability is enhanced.

An eight aspect of the invention provides an electric compressor comprising a compression mechanism having a stationary scroll and a movable scroll which suck, compress and discharge a refrigerant, a drive shaft which turns the movable scroll with respect to the stationary scroll, a main bearing member which sandwiches the main shaft between itself and the stationary scroll and which holds the drive shaft, an electric motor connected to the drive shaft, and a container which accommodates the electric motor and whose opening end is butted against and connected to the main bearing member, wherein the main bearing member is provided with an inserting portion inserted into the opening end of the container, and with an abutting portion which abuts against an opening end surface of the container, and at least one of the inserting portion and the abutting portion is provided with seal means which seals between inside and outside of the container.

With this structure, the centering operation of the scroll compression mechanism including the rotor of the electric motor can previously be carried out and then, the centering operation between the rotor and the stator of the electric motor can be carried out. Therefore, a complicated operation for centering between the scroll compression mechanism and the electric motor using a pin becomes unnecessary, and the reliability and performance of the scroll compressor are secured. Since the high pressure portion and the atmosphere are reliably isolated from each other by the seal means, the reliability is further enhanced.

A ninth aspect of the invention provides an assembling method of an electric compressor which comprises a compression mechanism having a stationary scroll and a movable scroll which suck, compress and discharge a refrigerant, a drive shaft which turns the movable scroll with respect to the stationary scroll, a main bearing member which sandwiches the main shaft between itself and the stationary scroll and which holds the drive shaft, an electric motor connected to the drive shaft, and a bottomed cylindrical container which accommodates the electric motor and whose opening end is butted against and connected to the main bearing member, in which the main bearing member is provided with an inserting portion inserted into the opening end of the container, and with an abutting portion which abuts against an opening end surface of the container, and at least one of the inserting portion and the abutting portion is provided with seal means which seals between inside and outside of the container, wherein the assembling method comprises the steps of: assembling and unitizing the stationary scroll, the movable scroll, a rotor of the electric motor, the drive shaft and the main bearing member; providing a bottom of the container with one end of an auxiliary bearing, providing an inner peripheral wall surface of the container with a stator of the electric motor, thereby unitizing these elements; and butting the opening end of the unitized container against the unitized main bearing member, inserting the inserting portion of the main bearing member into the opening end of the container so that an end of the drive shaft closer to the rotor is pivotally supported by the auxiliary bearing, and in a state in which the opening end surface of the container and the abutting portion are abutted against each other, the unitized compression mechanism and the unitized container are fastened to each other in an axial direction.

With this method, by fastening the unitized compression mechanism and the unitized electric motor in the axial direction, the centering operation of both the elements can be carried out, the assembling operability is excellent, variation of the assembling precision can be suppressed, and the quality of the compressor can be stabilized.

### BRIEF DESCRIPTION OF THE DRAWINGS

FIG. 1 is a sectional plan view of an electric compressor showing an embodiment of the present invention;

FIG. 2 is an enlarged sectional view of another embodiment of a portion A (a joint portion between a main bearing member and a container) in FIG. 1;

FIG. 3 is an enlarged sectional view of further another embodiment of the portion A (the joint portion between the main bearing member and the container) in FIG. 1;

FIG. 4 is an enlarged sectional view of further another embodiment of the portion A (the joint portion between the main bearing member and the container) in FIG. 1; and

FIG. 5 is an enlarged sectional view of further another embodiment of the portion A (the joint portion between the main bearing member and the container) in FIG. 1.

### BEST MODE FOR CARRYING OUT THE INVENTION

An embodiment of the present invention will be explained with reference to the drawings. It should be understood that the invention is not limited to the embodiments.

(First Embodiment)

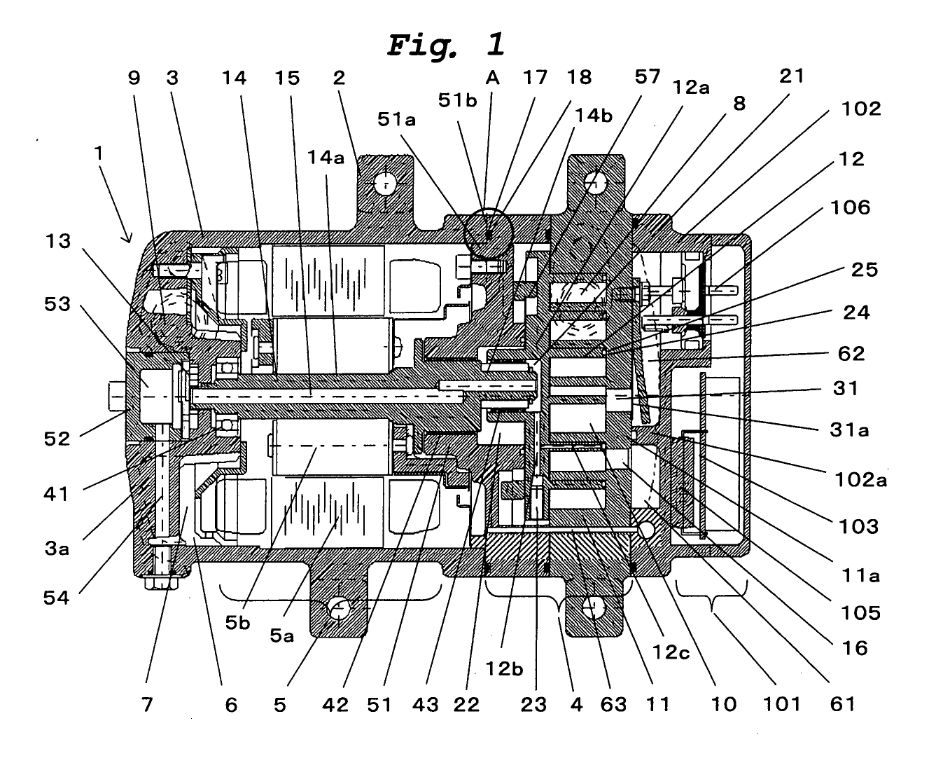

FIG. 1 shows one example of a lateral type electric compressor which is disposed laterally by two pairs of legs 2 provided around a body of an electric compressor 1.

In FIG. 1, the electric compressor 1 comprises a bottomed cylindrical container 3 in which an electric motor 5 is accommodated. The electric motor 5 comprises a stator 5a and a rotor 5b. The electric compressor 1 further comprises a compression mechanism 4 which is fastened to the container 3 in its axial direction by using a bolt (not shown) and which is driven by a drive shaft 14 of the electric motor 5.

A liquid reservoir 6 for storing liquid used for lubricating various sliding parts including the compression mechanism 4 is provided in the container 3. The container 3 is provided at its axial one end with a motor driving circuit 101 which drives the electric motor 5.

A gas refrigerant is used as a refrigerant in the electric compressor 1. Liquid such as lubricant 7 is used for lubricating the sliding parts and for sealing sliding parts of the compression mechanism 4. A lubricant 7 which is mutually soluble with respect to the refrigerant is used.

However, the present invention is not limited to these conditions only if the electric compressor 1 basically comprises the compression mechanism 4 which sucks, compresses and discharges gas such as the gas refrigerant, the container 3 accommodating the electric motor 5 which drives the compression mechanism 4, and the motor driving circuit 101 which drives the electric motor 5.

The compression mechanism 4 of the electric compressor 1 of this embodiment is of scroll type for example.

That is, as shown in FIG. 1, the compression mechanism 4 includes a stationary scroll 11 and a movable scroll 12. The stationary scroll 11 and the movable scroll 12 have blades which respectively rise from a stationary mirror plate 11a and a turning mirror plate 12a. By meshing the stationary scroll 11 and the movable scroll 12 with each other, a plurality of compressed spaces 10 are formed as in the known technique. When the movable scroll 12 is turned or rotated with respect to the stationary scroll 11 as the drive shaft 14 is rotated by the electric motor 5, a capacity of each of the compressed spaces 10 is gradually reduced as the movable scroll 12 turns and finally a compressed fluid is discharged by the compression mechanism 4.

By continuously carrying out this operation, the refrigerant which returned from an external cycle is repeatedly sucked, compressed and discharged to the external cycle. Here, the refrigerant which returned from the external cycle is sucked, compressed and discharged to the external cycle through a suction port 8 (shown with broken lines) provided in the compression mechanism 4 and a discharge port 9 (shown with broken lines) provided in the container 3.

If the electric motor 5 is driven, the lubricant 7 stored in the liquid reservoir 6 of the container 3 is supplied to various portions by appropriate methods, such as a supplying effect of a positive-displacement pump 13 which is driven by the drive shaft 14, and a method utilizing a pressure difference in the container 3.

More specifically, the lubricant 7 passes through an oil supply passage 15 formed in a main shaft 14a and a crankshaft 14b of the drive shaft 14, and is supplied to a liquid reservoir 21 formed in a back surface of the movable scroll 12 which is turning, and to a liquid reservoir 22 which is in communication with the liquid reservoir 21 through the crank bearing 43.

The turning mirror plate 12a is provided with an oil supply passage 12b extending in its radial direction. The oil supply passage 12b is provided at its outer peripheral opening end with a throttle portion 23 comprising a screw mechanism. A fine gap through which the lubricant 7 passes is formed between screw grooves. A portion of the blade of the turning spiral portion 12 is provided with a thin passage 12c. One end of the thin passage 12c is in communication with the oil supply passage 12b, and the other end of the thin passage 12c opens at the retention groove 25 provided in the tip end of the blade of the stationary mirror plate 11a of the stationary scroll 11. The retention groove 25 is provided with a chip seal 24 which seals between the movable scroll 12 and the stationary scroll 11.

Therefore, a portion of the lubricant 7 supplied to the liquid reservoir 21 flows into the oil supply passage 12b of the turning mirror plate 12a, backs up the lubrication of the movable scroll 12 based on a predetermined flow rate limit determined by the throttle portion 23, and the lubricant 7 is supplied to the chip seal 24 and the retention groove 25 on the tip end of the blade of the movable scroll 12 through the movable scroll 12, and the lubricant 7 seals and lubricates between the stationary scroll 11 and the turning spiral portion 12.

A portion of the lubricant 7 supplied to the liquid reservoir 21 passes through an eccentric bearing 43, the liquid reservoir 22 and a main bearing 42 to lubricate the bearings 42 and 43 and then, the portion of the lubricant 7 flows out toward the electric motor 5 and is collected into the liquid reservoir 6.

In the container 3, there are disposed the positive-displacement pump 13, an auxiliary bearing 41, the electric motor 5 (stator 5a and rotor 5b), and a main bearing member 51 having the main bearing 42, and these members are arranged from one end wall 3a of the container 3 in the axial direction.

The positive-displacement pump 13 is accommodated from an outer surface of the end wall 3a and then, the pump 13 is held between the end wall 3a and the fitted lid 52, and a pump chamber 53 is formed inside of the lid 52. The pump chamber 53 is in communication with the liquid reservoir 6 through a pumping passage 54.

The auxiliary bearing 41 is supported by the end wall 3a, and receives one end of the drive shaft 14 that is connected to the positive-displacement pump 13.

The stator 5a of the electric motor 5 is fixed to an inner periphery of the container 3 by shrinkage fitting, and the drive shaft 14 can be rotated by the rotor 5b fixed to a central portion of the drive shaft 14 and the stator 5a.

The main bearing member 51 is fitted into an open end of the container 3. The main bearing member 51 is fixed in a state in which the main bearing member 51 is sandwiched between the stationary scroll 11 and a sub-casing 102 by means of appropriate means (not shown) such as a bolt. One end of the drive shaft 14 on the side of the compression mechanism 4 is received by the main bearing 42. The movable scroll 12 is sandwiched between the main bearing member 51 and the stationary scroll 11 to constitute the scroll compressor.

A rotation-restraining portion 57 such as an Oldham ring is provided between the main bearing member 51 and the movable scroll 12. The rotation-restraining portion 57 prevents the movable scroll 12 from rotating, and allows the movable scroll 12 to circulate (circular motion). The drive shaft 14 is connected to the movable scroll 12 through the eccentric bearing 43, and the movable scroll 12 is allowed to circulate on a circular orbit.

The compression mechanism 4 is provided with a discharge hole 31 and a reed valve 31a. The discharge hole 31 is opened at a discharge chamber 62 formed between a sub-casing 102 and the compression mechanism 4. The discharge chamber 62 is in communication with the electric motor 5 having a discharge port 9 between the compression mechanism 4 and the end wall 3a through a communication passage 63 formed between the stationary scroll 11 and the main bearing member 51 or between these members and the container 3.

The motor driving circuit 101 accommodates, in the sub-casing 102, a circuit substrate 103 located on the opposite sides from a suction chamber 61 and the discharge chamber 62, and an electrolytic capacitor (not shown) separated by an end wall 102a. An IPM (intelligent power module) 105 including a switching element is mounted on the circuit substrate 103. The switching element generates high temperature.

A motor driving circuit 101 is electrically connected to the electric motor 5 through a compressor terminal 106. The motor driving circuit 101 drives the electric motor 5 while monitoring necessary information such as temperature. Thus, the motor driving circuit 101 is provided with a harness connector (not shown) which is electrically connected to outside.

With the above structure, the electric motor 5 is driven by the motor driving circuit 101. The electric motor 5 moves the compression mechanism 4 is allowed to move in the circular orbit through the drive shaft 14, and drives the positive-displacement pump 13. At that time, the compression mechanism 4 is supplied the lubricant 7 from the liquid reservoir 6 by the positive-displacement pump 13. The compression mechanism 4 sucks the refrigerant which returned from a refrigeration cycle through a suction port 16 provided in the stationary scroll 11 while carrying out the lubrication and sealing operations. The compression mechanism 4 compresses the sucked refrigerant and discharges the refrigerant from the discharge hole 31 to the discharge chamber 62.

The refrigerant which was discharged into the discharge chamber 62 enters the electric motor 5 through the communication passage 63, cools the electric motor 5, and is subjected to various gas/liquid separating operation such as collision, centrifugal action, throttling action and the like during the long process until the refrigerant is discharged from the discharge port 9 of the container 3, and the lubricant 7 is separated from the refrigerant, but a portion of the lubricant 7 which remains on the refrigerant lubricates the auxiliary bearing 41.

In the electric compressor 1 having the above-described structure, when the main bearing member 51 is to be fitted into the opening end of the container 3, a relative relation between the electric motor 5 and the drive shaft 14, i.e., a so-called centering is important.

That is, the main bearing member 51 and the container 3 are deviated from the coaxial state, a contact force in the radial direction more than necessary is generated between the drive shaft 14 and the auxiliary bearing 41 or the main bearing 42. This fact increases the compressor input and deteriorates the performance of the compressor, and may damage the bearing member in some cases.

Therefore, in the embodiment shown in FIG. 1, the outer peripheral surface of the main bearing member 51 is provided with a step having a different outer diameter, thereby forming an abutment portion and an inserting portion. The abutment portion is an opening end surface 51b, and the inserting portion corresponds to the outer peripheral diameter of a flange 51a which is fitted into the inner peripheral surface of the container 3. By setting the outer diameter on the side of a small diameter of the flange 51a to a fitting size corresponding to an inner diameter of the opening end of the container 3, the center axis of the container 3 and the center axis of the main bearing member 51 match each other precisely, and the centering can be carried out precisely.

At that time, a seal structure is required so that a high pressure gas in the container 3 does not leak from the fitting gap between the main bearing member 51 and the container 3. In this embodiment, as shown with the portion A in FIG. 1, in the main bearing member 51, a seal groove 17 is provided in the entire periphery of the opening end surface 51b which abuts against the opening end of the container 3, and an annular seal ring 18 is disposed in the seal groove 17. With this, the above problem can easily be solved.

(Second Embodiment)

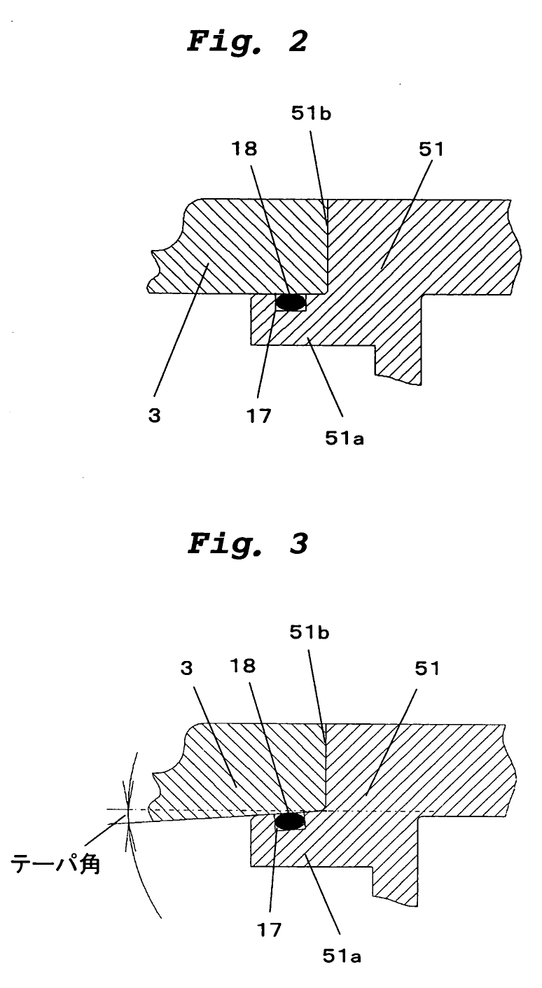

In FIG. 2, in the electric compressor 1 shown in the first embodiment, the seal groove 17 is formed in the outer periphery of the flange 51a, and the annular seal ring 18 is disposed in the seal groove 17.

With this structure also, reliable sealing effect can be obtained.

(Third Embodiment)

In FIG. 3, in the second embodiment, an outer periphery of the flange 51a is formed into a truncated shape such that the outer periphery becomes gradually thinner toward the opening end, and the inner peripheral surface of the container 3 is formed such that the thickness thereof is gradually reduced toward the opening end.

The flange 51a is formed at its outer periphery with the seal groove 17, and the annular seal ring 18 is disposed in the seal groove 17.

With this structure, cylindrical tapered surfaces of the outer peripheral surface of the flange 51a and the inner peripheral surface of the container 3 abut against each other. With this, the fitting operation can smoothly be carried out, and they can be assembled without damaging the seal ring 18.

(Fourth Embodiment)

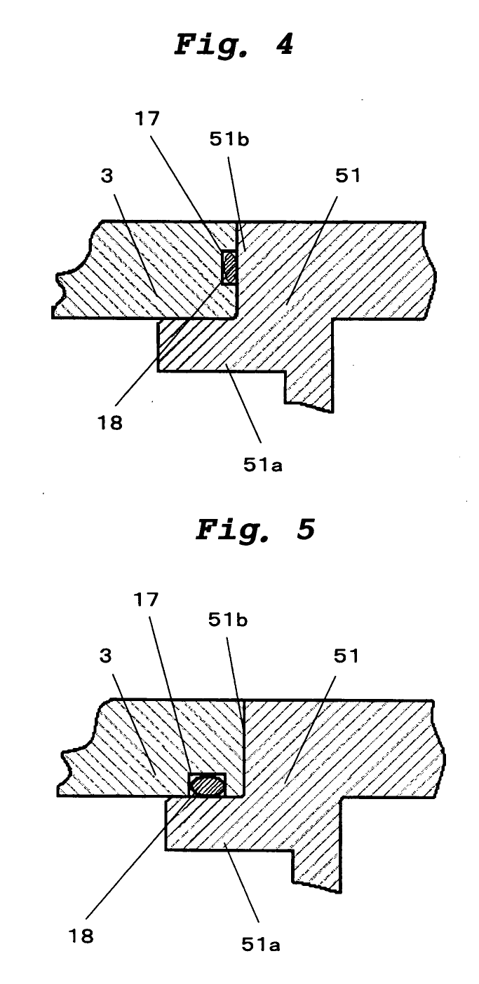

Similarly, as shown in FIG. 4 or 5, the container 3 is provided with the seal groove 17 and the seal ring 18, and the sealing performance can be secured.

These sealing structures may be a combination of the plurality of sealing structures of the previous embodiments.

Next, an assembling method of the scroll compressor of the embodiment will be explained.

First, the stationary scroll 11, the movable scroll 12, the rotor 5b of the electric motor 5, the drive shaft 14, and the main bearing member 51 are previously assembled to unitize the compression mechanism 4.

One end of the auxiliary bearing 41 is provided on the bottom of the container 3, the stator 5a of the electric motor 5 is provided on the inner peripheral wall surface of the container 3, thereby unitizing these elements.

After the compression mechanism 4 and the container 3 are unitized in this manner, the opening end of the container 3 and the main bearing member 51 are abutted against each other, and the inserting portion of the main bearing member 51 is inserted into the opening end of the container 3. The end of the drive shaft 14 closer to the rotor is pivotally supported by the auxiliary bearing 41, and the abutting portion and the opening end surface of the container 3 are brought into abutment against each other. In this state, the unitized compression mechanism 4 and the unitized container 3 are fastened to each other in the axial direction.

According to this method, since the unitized compression mechanism 4 and the unitized container 3 are fastened to each other in the axial direction, the centering operation of both the members can be carried out, they can be assembled excellently, variation of assembling precisions can be suppressed, and quality can be stabilized.

The present invention can be utilized as an electric compressor used for air conditioning or for a water heater.

1. An electric compressor comprising a compression mechanism which sucks, compresses and discharges a refrigerant, a drive shaft which drives said compression mechanism, a main bearing member which holds said drive shaft, an electric motor which drives said drive shaft, and a container which accommodates said electric motor, in which said compression mechanism, said main bearing member and said container are axially butted and connected to each other, wherein said main bearing member is provided at its peripheral edge with an inserting portion and an abutting portion, an outer diameter of said inserting portion is set smaller than an outer diameter of said abutting portion, and the outer diameter of said inserting portion is set slightly smaller than an inner diameter of an opening end of said container.

2. The electric compressor according to claim 1, wherein said compression mechanism comprises a stationary scroll, a movable scroll and the drive shaft which turns said movable scroll, and in a state in which a rotor of said electric motor is previously fixed to said drive shaft, said stationary scroll, said main bearing member and said container are axially butted against and connected to each other.

3. The electric compressor according to claim 1, wherein seal means which seals between the atmosphere and a high pressure chamber in said container is provided on any one of a abutment surface between said main bearing member abutting portion and said container, a fitting surface between said inserting portion and said container, an abutment surface of said container which abuts against said abutting portion, and an inner peripheral surface of said container which is fitted to said inserting portion.

4. The electric compressor according to claim 3, wherein said seal means comprises an annular groove provided in said abutment surface of said abutting portion, and an annular seal provided on said groove.

5. The electric compressor according to claim 3, wherein said seal means comprises a groove formed in an entire outer peripheral surface of said inserting portion, and an annular seal provided on said groove.

6. The electric compressor according to claim 4 or 5, wherein said annular seal is made of rubber.

7. The electric compressor according to claim 1, wherein said inserting portion of said main bearing member is formed into a truncated shape whose outer diameter is gradually reduced toward its tip end, a thickness of the opening end of said container to which said inserting portion is inserted becomes gradually reduced toward the opening end such that an inner peripheral surface thereof matches with an outer diameter of said inserting portion.

8. An electric compressor comprising a compression mechanism having a stationary scroll and a movable scroll which suck, compress and discharge a refrigerant, a drive shaft which turns said movable scroll with respect to said stationary scroll, a main bearing member which sandwiches said main shaft between itself and said stationary scroll and which holds said drive shaft, an electric motor connected to said drive shaft, and a container which accommodates said electric motor and whose opening end is butted against and connected to said main bearing member, wherein said main bearing member is provided with an inserting portion inserted into the opening end of said container, and with an abutting portion which abuts against an opening end surface of said container, and at least one of said inserting portion and said abutting portion is provided with seal means which seals between inside and outside of said container.

9. An assembling method of an electric compressor which comprises a compression mechanism having a stationary scroll and a movable scroll which suck, compress and discharge a refrigerant, a drive shaft which turns said movable scroll with respect to said stationary scroll, a main bearing member which sandwiches said main shaft between itself and said stationary scroll and which holds said drive shaft, an electric motor connected to said drive shaft, and a bottomed cylindrical container which accommodates said electric motor and whose opening end is butted against and connected to said main bearing member, in which said main bearing member is provided with an inserting portion inserted into the opening end of said container, and with an abutting portion which abuts against an opening end surface of said container, and at least one of said inserting portion and said abutting portion is provided with seal means which seals between inside and outside of said container, wherein said assembling method comprises the steps of:
assembling and unitizing said stationary scroll, said movable scroll, a rotor of said electric motor, said drive shaft and said main bearing member;
providing a bottom of said container with one end of an auxiliary bearing, providing an inner peripheral wall surface of said container with a stator of said electric motor, thereby unitizing these elements; and
butting said opening end of said unitized container against said unitized main bearing member, inserting said inserting portion of said main bearing member into said opening end of said container so that an end of said drive shaft closer to said rotor is pivotally supported by said auxiliary bearing, and in a state in which the opening end surface of said container and said abutting portion are abutted against each other, said unitized compression mechanism and said unitized container are fastened to each other in an axial direction.
